(19) United States
(12) Patent Application Publication
(10) Pub. No.: US 2011/0265883 A1
(43) Pub. Date: Nov. 3, 2011

(54) METHODS AND APPARATUS FOR REDUCING FLOW SPLITTING ERRORS USING ORIFICE RATIO CONDUCTANCE CONTROL

(75) Inventors: JAMES P. CRUSE, Santa Cruz, CA (US); EZRA ROBERT GOLD, Sunnyvale, CA (US); JARED AHMAD LEE, Santa Clara, CA (US); MING XU, San Jose, CA (US); CORIE LYNN COBB, Mountain View, CA (US); ANDREW NGUYEN, San Jose, CA (US); JOHN W. LANE, San Jose, CA (US)

(73) Assignee: APPLIED MATERIALS, INC., Santa Clara, CA (US)

(21) Appl. No.: 12/907,942

(22) Filed: Oct. 19, 2010

Related U.S. Application Data
(60) Provisional application No. 61/330,047, filed on Apr. 30, 2010.

(51) Int. Cl. F17D 3/00; F16K 7/00

(52) U.S. Cl. 137/8; 137/861

(57) ABSTRACT

Methods and apparatus for gas delivery to a process chamber are provided herein. In some embodiments, an apparatus for processing substrates may include a mass flow controller to provide a desired total fluid flow; a first flow control manifold comprising a first inlet, a first outlet, and a first plurality of orifices selectably coupled therebetween, wherein the first inlet is coupled to the mass flow controller; and a second flow control manifold comprising a second inlet, a second outlet, and a second plurality of orifices selectably coupled therebetween, wherein the second inlet is coupled to the mass flow controller; wherein a desired flow ratio between the first outlet and the second outlet is selectably obtainable when causing the fluid to flow through one or more of the first plurality of orifices of the first manifold and one or more of the second plurality of orifices of the second manifold.

### CROSS-REFERENCE TO RELATED APPLICATIONS

This application claims benefit of U.S. provisional patent application Ser. No. 61/330,047, filed Apr. 30, 2010, which is herein incorporated by reference.

### FIELD

Embodiments of the present invention generally relate to substrate processing.

### BACKGROUND

Ultra-large-scale integrated (ULSI) circuits may include more than one million electronic devices (e.g., transistors) that are formed on a semiconductor substrate, such as a silicon (Si) substrate, and cooperate to perform various functions within the device. Plasma etching is commonly used in the fabrication of transistors and other electronic devices. During plasma etch processes used to form such transistor structures, one or more process gases (etchants), may be provided to a process chamber where a substrate is disposed in order to etch one or more layers of materials. During some etching processes, the one or more gases may be provided to two or more regions, or zones, within the process chamber. In such applications, active flow controllers, such as flow sensors and flow controllers controlled based upon sensed flow, may be used to actively control the flow of the one or more gases provided to the process chamber zones.

However, the inventors have observed that, in certain applications, the active control devices may fail and indicate a sudden change in the measured flow down the controlled path for the flow splitter. The inventors believe that this failure may be related to a thermal reaction occurring when the gasses mix and have an endothermic or exothermic reaction, causing the active flow sensors determine the flow erroneously. This may undesirably cause production variation or failures due to attempts to correct the gas flow when no correction is needed and may further lead to downtime of the process chamber if process controllers fault the process chamber for being out of control. In addition, the inventors have further observed general process drift in the active flow ratio controllers.

Alternatively, combinations of fixed orifices may be used to try to control the flow of the one or more gases provided to the process chamber zones. However, the inventors have observed that such fixed orifice devices are unsatisfactory for providing multiple flow ratios for processes having dynamic (e.g., changing) ratio requirements.

Therefore, the inventors have provided improved methods and apparatus for controlling gas flow.

### SUMMARY

Methods and apparatus for gas delivery to a process chamber are provided herein. In some embodiments, an apparatus for processing substrates may include a mass flow controller to provide a desired total fluid flow; a first flow control manifold comprising a first inlet, a first outlet, and a first plurality of orifices selectably coupled therebetween, wherein the first inlet is coupled to the mass flow controller; and a second flow control manifold comprising a second inlet, a second outlet, and a second plurality of orifices selectably coupled therebetween, wherein the second inlet is coupled to the mass flow controller; wherein a desired flow ratio between the first outlet and the second outlet is selectably obtainable when causing the fluid to flow through one or more of the first plurality of orifices of the first manifold and one or more of the second plurality of orifices of the second manifold.

In some embodiments, a method for controlling gas distribution to multiple gas delivery zones may include selecting a desired flow ratio of a desired gas between a first gas delivery zone and a second gas delivery zone; determining a first selected set from a plurality of first orifices selectively coupled to the first gas delivery zone and a second selected set from a plurality of second orifices selectively coupled to the second gas delivery zone that can provide the desired flow ratio; and flowing the desired gas to the first and second gas delivery zones through the first and second selected sets of orifices.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic view of an exemplary gas distribution system in accordance with some embodiments of the present invention.

FIGS. 2A-C respectively depict partial schematic views of gas delivery zones coupled to the gas distribution system of FIG. 1 in accordance with some embodiments of the present invention.

FIG. 3 depicts a flow diagram for dividing a gas in a desired flow ratio in accordance with some embodiments of the present invention.

FIG. 4 depicts a flow diagram for dividing a gas in a desired flow ratio in accordance with some embodiments of the present invention.

FIG. 5 depicts a flow diagram for dividing a gas in a desired flow ratio in accordance with some embodiments of the present invention.

FIG. 6 depicts a controller suitable for use with embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention provide a gas distribution system for delivery of a gas to a chamber and methods of use thereof. The inventive apparatus and methods advantageously provides a gas delivery to a process chamber in a desired flow ratio. The apparatus provides for this in a passive manner, without the use of active flow controls. Specifically, the inventive apparatus utilizes a plurality of precision orifices arranged in two flow control manifolds that can be selectively coupled between a gas source and a desired gas delivery zone. Embodiments of the present invention further provide methods to determine correct orifice sizes to both passively maintain a choked flow condition for proper conductance control, while simultaneously selecting orifice sizes that passively maintain upstream pressure to be low enough to prevent condensation of low vapor pressure gasses upstream.

Thus, the present methods and apparatus may advantageously provide and select the size of the orifices to obtain desired flow ratios, and may further facilitate selection amongst various orifices to simultaneously provide choked flow for a specific combination of gas flow and minimization of the upstream pressure to prevent phase change of low vapor pressure gases, and further provides an indication when a specific ratio cannot be achieved by either due to inability to maintain choked flow or by exceeding the upstream pressure required to prevent phase change of the process gases flowing through the gas distribution system.

Embodiments of the present invention provide a gas distribution system that passively divides a gas flowing therethrough in to desired flow ratio. The apparatus is based on the fundamental principle that flow through an orifice is directly proportional to the cross-sectional area. If a gas stream is split between two orifices where one is twice as large (in cross-sectional area) as the other, the ratio of the flows will be two to one. However, this principle is dependent on both orifices having the same upstream and downstream pressures. In the present invention, different gas delivery zones coupled to the apparatus (e.g., zones of a showerhead, different process chambers, or the like) may have different conductance, or resistance to flow and, thus, the downstream pressures may not be the same. In some embodiments, the inventors have eliminated this issue by designing the apparatus to always operate in a choked flow condition (e.g., the upstream pressure is at least twice the downstream pressure). If flow is choked, then the flow will only be a function of the upstream pressure.

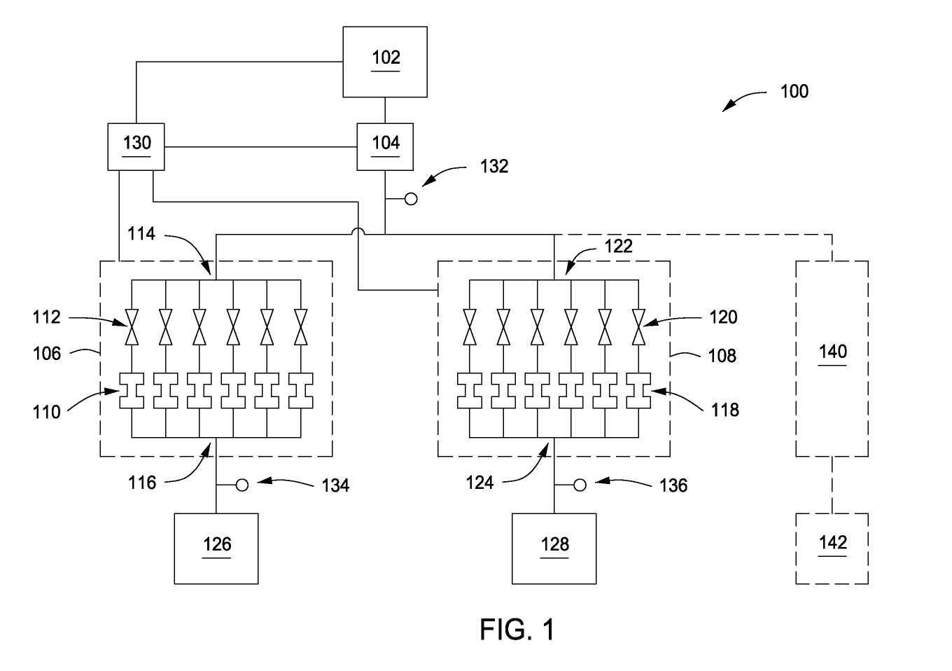

For example, FIG. 1 depicts a schematic view of an exemplary gas distribution system 100 in accordance with some embodiments of the present invention. Although the system depicted in FIG. 1 primarily relates to providing a gas flow to two gas delivery zones (e.g., 126, 128), the system may be expanded in accordance with the principles disclosed herein to providing the gas flow to additional gas delivery zones (e.g., 142, as shown in phantom). The gas distribution system 100 generally includes one or more mass flow controllers (one mass flow controller 104 shown), a first flow control manifold 106, and a second flow control manifold 108 (additional flow control manifolds, similarly configured as described herein, may be provided, as shown by reference numeral 140 in phantom). The mass flow controller 104 is typically coupled to a gas distribution panel 102 that provides one or more gases or gaseous mixtures (referred to throughout and in the claims as a gas). The mass flow controller 104 controls the total flow rate of the gas through the gas distribution apparatus 100 and is coupled to both of the first and second flow control manifolds 106, 108 at respective inlets thereof. Although one mass flow controller 104 is shown, a plurality of mass flow controllers may be coupled to the gas distribution panel 102 to meter respective process gases from the gas distribution panel 102. The outputs of the one or more mass flow controllers 104 are generally coupled (e.g., fed into a common conduit, mixer, plenum, or the like, or combinations thereof) prior to being split and routed to each flow control manifold (e.g., 106, 108).

The first flow control manifold 106 includes a plurality of first orifices 110 and a plurality of first control valves 112 coupled between an inlet 114 and an outlet 116 of the first flow control manifold 106. The plurality of first control valves 112 may be selectively opened or closed in order to selectively couple one or more of the plurality of first orifices 110 to the outlet of the mass flow controller 104 (e.g., to allow the gas to flow from the mass flow controller 104 through the selected first orifices 110).

Similarly, the second flow control manifold 108 includes a plurality of second orifices 118 and a plurality of second control valves 120 coupled between an inlet 122 and an outlet 124 of the second flow control manifold 108. The plurality of second control valves 120 may be selectively opened or closed in order to selectively couple one or more of the plurality of second orifices 118 to the mass flow controller 104 (e.g., to allow the gas to flow through the selected second orifices 118). Similarly additional flow control manifolds (such as 140) may be provided to provide a gas in a desired flow ratio to additional gas delivery zones (such as 142).

The first and second control valves 112, 120 may be any suitable control valves for use in a industrial environment, or in a semiconductor fabrication environment. In some embodiments, the first and second control valves 112, 120 may be pneumatically actuated valves. In some embodiments, the first and second control valves 112, 120 may be mounted on a substrate (not shown) where the seals for each control valve had a precision orifice built into the structure of the seal. In some embodiments, the orifices may be built into the body of the control valves. In some embodiments, separate control valves and orifices may be provided.

In the embodiment depicted in FIG. 1, six first orifices 110 and six second orifices 118 are shown, each coupled to respective first control valves 112, and respective second control valves 120. However, each flow control manifold does not need to have the same number of orifices—although having the same number and configuration of orifices facilitates ease of providing the same flow ratios between the first and second gas delivery zones 126, 128 regardless of whether the ratio is between the first and the second gas delivery zones 126, 128 or between the second and the first gas delivery zones 128, 126. In addition, each zone may have a fewer or greater number of orifices than six. Generally speaking, fewer orifices allows fewer flow ratios to be provided, and more orifices allow more flow ratios to be provided, but at greater cost and complexity. As such, the number of orifices provided may be selected based upon the desired processing flexibility required for a particular application.

The configuration of the gas distribution system 100 may be determined based upon the anticipated operating conditions and output requirements for a particular application. For example, in some embodiments, the gas distribution system 100 may provide flow ratios between 1:1 and 6:1 in half ratio increments (i.e., 1/1, 1.5/1, 2/1, 2.5/1 . . . 6/1) and must be fully reversible (i.e., 1/1, 1/1.5, 2/1, 2.5/1 . . . 1/6) between the gas delivery zones 126, 128. In some embodiments, the accuracy of the gas flow split may be within 5 percent, for example, to match the performance of existing equipment. In some embodiments, the gas distribution system 100 may be designed to ratio properly for a gas flow between 50 and 500 sccm nitrogen equivalent per gas delivery zone 126, 128 and is compatible with all process gases. In some embodiments, the upstream pressure (or back pressure) of the gas distribution system 100 may be minimized to reduce the response time of the gas distribution system 100. In addition, the upstream pressure (or back pressure) of the gas distribution system 100 may be restricted or minimized to prevent the undesirable condensation of some low vapor pressure gases (for example, silicon tetrachloride, SiCl₄). As such, in some embodiments, the restricted upstream pressure is low enough to prevent condensation of low vapor pressure gases. For example, the first and second flow control manifolds may provide a pressure drop sufficient to maintain choked flow while minimizing the pressure upstream of the orifice(s) to prevent condensation of any semiconductor process chemistries whose vapor pressure at the use temperature could approach the pressure upstream of the orifice. Low vapor pressure gases include gases that leave the gas phase (i.e., liquefy) at the operating pressure and temperature. Non-limiting examples include about 150 Torr for SiCl₄, about 100 Torr for C₆F₆, about 5 psig for C₄F₈, and the like. In some embodiments, the maximum allowable restricted upstream pressure was designed to be the vapor pressure of SiCl₄ at room temperature, or 155 Torr.

Typically, the upstream pressure may be minimized to minimize response time of the system. For example, at a given flow rate, the volume between the flow controller and the orifice will take some period of time to reach a desired pressure and provide steady state flow. Thus, higher pressures will require a longer period of time to fill this volume to the higher pressure and thus take longer to achieve steady state flow. In some embodiments, the volume between the flow controller and the orifices may be minimized to minimize response time. However, in some embodiments, the restricted upstream pressure may be controlled to optimize the response time of the system, for example, to control to a specific response time to match other systems. As such, in some embodiments, the first and second flow control manifolds may provide a pressure drop sufficient to maintain choked flow while controlling the pressure upstream of the orifice(s) to control the response time of the system. Such control may be provided, for example, by controlling the volume between the flow controller and the orifices, by intentionally selecting more restrictive orifices to create higher back pressures, or the like. Different applications and/or processes may have different desired response times (e.g., optimized response times) based upon the specific process being performed (e.g., etching, chemical vapor deposition, atomic layer deposition, physical vapor deposition, or the like). In some embodiments, the desired response time may be 2 seconds or less, or 5 seconds or less, or 10 seconds or less, or 15 seconds or less.

In some embodiments, flow modeling software (such as Macroflow) may be used to select the desired sizes of the first and second orifice 110, 118 for each of the first and second flow control manifolds 106, 108 in order to meet the requirements for etch processing. For example, in some embodiments, this may be determined by finding the largest orifice that will still yield choked flow for the minimum desired process gas flow. In some embodiments, 6 orifices per zone may be provided with increments in orifice size of 1, 1.5, 2, 4, 8, and 12 (e.g., multiplication factors). In some embodiments, the smallest orifice diameter may be 0.0090″ (for example, to provide choked flow at a smallest desired flow) and all orifice diameters are multiples of the smallest orifice diameter. In some embodiments, the orifice diameters may be 0.009, 0.011, 0.013, 0.018, 0.025, and 0.031 inch. Orifices having these diameters are commercially available orifice diameters, and may be selected rather than diameters that would provide exact ratios of cross-sectional area in order to provide a more cost-effective solution where repeatability and reproducibility are more important than exact ratios. For example, the modeling showed that with this configuration, all ratios and all flows between 10 and 1200 sccm nitrogen equivalent per zone could meet both the choked flow and maximum back pressure requirements.

In some embodiments, using the orifice diameters described above, the gas delivery system 100 may be capable of providing a gas flow of from about 16 sccm to about 2300 sccm at a 1:1 flow ratio, and a gas flow of from about 40 sccm to about 1750 sccm at a 4:1 flow ratio. These flow rate ranges are expressed in terms of nitrogen equivalent gas flow, as discussed in more detail below.

The outlets 116, 124 of the first and second flow control manifolds 106, 108 may be respectively coupled to a first gas delivery zone 126 and a second gas delivery zone 128. Each gas delivery zone 126, 128 may thus receive a desired percentage of the total gas flow provided by the mass flow controller 104 based upon a desired flow ratio imposed by the selective coupling of the first orifices 110 and the second orifices 118. The gas delivery zones 126, 128 may generally be any zones where control over the gas flow ratio is desired.

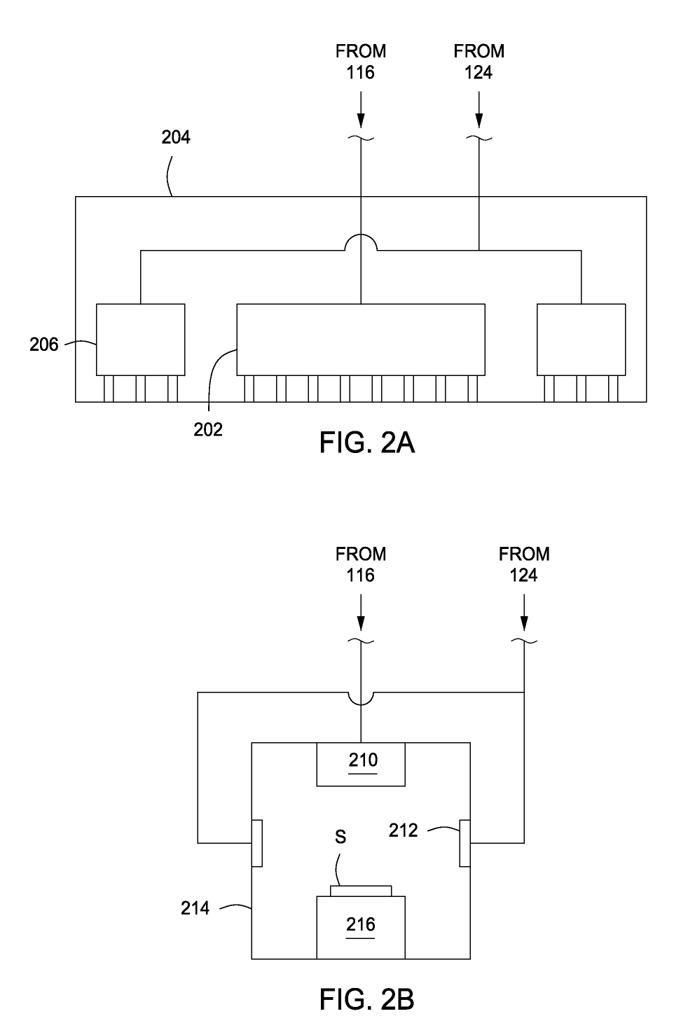

For example, in some embodiments, and as shown in FIG. 2A, the first gas delivery zone 126 may correspond to a first zone 202, such as an inner zone, of a showerhead 204 for providing the gas to a process chamber in which the showerhead 204 is installed. The second gas delivery zone 128 may correspond to a second zone 206, such as an outer zone, of the showerhead 204.

In some embodiments, as shown in FIG. 2B, the first and second gas delivery zones 126, 128 may be respectively provided to a showerhead 210 and one or more gas inlets 212 of a process chamber 214 having a substrate support 216 for supporting a substrate S thereon.

In some embodiments, as shown in the upper portion of FIG. 2C, the first and second gas delivery zones 126, 128 may be respectively provided to showerheads 220, 222 (and/or other gas inlets) of different process chambers 224, 226 having substrate supports 216 for supporting respective substrates S thereon. For example, in some embodiments, the first and second process chambers 224, 226 may be part of a twin chamber processing system. One example of a twin chamber processing system that may be modified to incorporate the present invention in accordance with the teachings herein is described in U.S. Provisional Patent Application Ser. No. 61/330,156, filed Apr. 30, 2010, by Ming Xu et al., and entitled, “Twin Chamber Processing System.”

Alternatively, and shown in the lower portion of FIG. 2C, the first and second gas delivery zones 126, 128 may be provided to both showerheads 220, 222 (and/or other gas inlets) of different process chambers 224. For example, the first gas delivery zone 126 may correspond to a first zone (such as first zone 202 of showerhead 204 as depicted in FIG. 2A) in each showerhead 220,222 and the second gas delivery zone 128 may correspond to a second zone (such as second zone 206 of showerhead 204 as depicted in FIG. 2A) in each showerhead 220, 222.

Further, although not shown in FIG. 2C, the first and second gas delivery zones 126, 128 need not be limited to being provided to two showerheads, and may be provided to any suitable plurality of showerheads in a plurality of process chambers. For example, the first gas delivery zone 126 may correspond to a first zone in a plurality of showerheads of a plurality of process chambers and the second gas delivery zone 128 may correspond to a second zone in a plurality of showerheads of a plurality of process chambers.

Returning to FIG. 1, one or more pressure gauges may be provided to monitor the pressure at desired locations of the gas distribution apparatus 100. For example, a pressure gauge 132 may be provided to monitor the upstream pressure of the gas distribution apparatus 100. In some embodiments, the pressure gauge 132 may be disposed in a gas line coupled between the mass flow controller 104 and the first and second flow control manifolds 106, 108. Pressure gauges 134, 136 may be provided to respectively monitor the downstream pressure of the gas distribution apparatus 100. In some embodiments, the pressure gauges 134, 136 may be respectively disposed in gas lines respectively coupled between the first and second flow control manifolds 106, 108 and the first and second gas delivery zones 126, 128.

A controller 130 may be provided and coupled to the gas distribution system 100 for controlling the components of the system. For example, the controller 130 may be coupled to the gas distribution panel 102 to select one or more process gases to provide, the mass flow controller 104 to set a desired flow rate, and to each of the first and second flow control manifolds 106, 108 (or to each of the first and second control valves 112, 120 contained therein) to control which control valves 112, 120 to open in order to provide the desired flow ratio. The controller may further be coupled to the pressure gauges 132, 134, 136 in order to ensure that the pressure requirements are being met for choked flow and minimized back pressure.

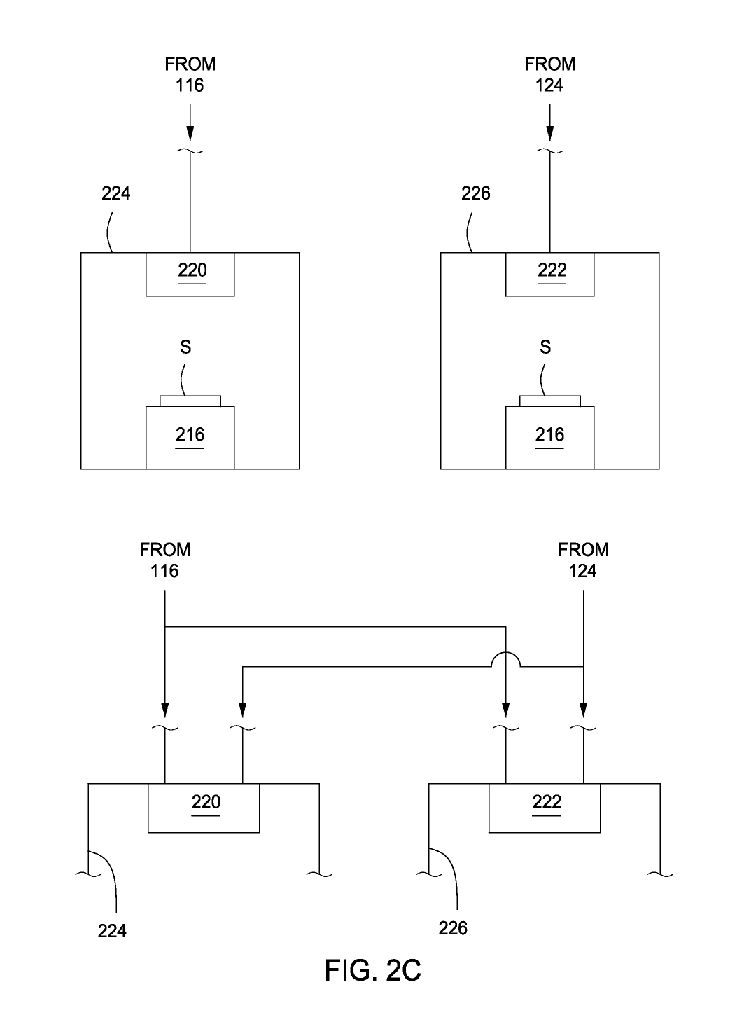

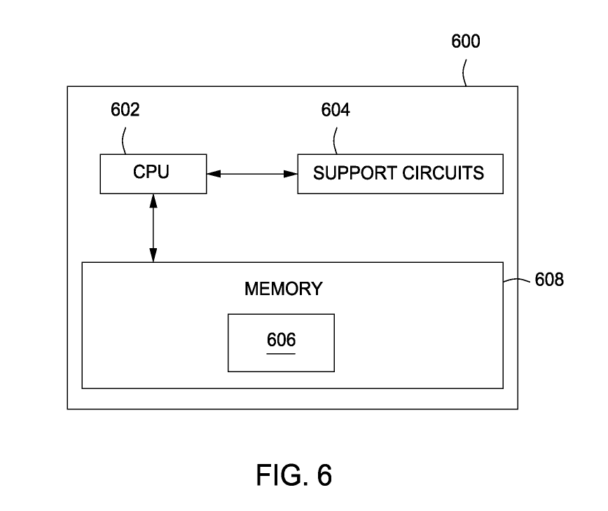

The controller 130 may be any suitable controller and may be the process controller for a process chamber or process tool to which the gas distribution system 100 is coupled, or some other controller. A suitable controller 130 is shown in FIG. 6, which depicts a controller 600 in accordance with some embodiments of the present invention. As shown in FIG. 6, the controller 600 generally includes a central processing unit (CPU) 602, a memory 608, and support circuits 604. The CPU 602 may be one of any form of a general purpose computer processor that can be used in an industrial setting. The support circuits 604 are coupled to the CPU 602 and may comprise cache, clock circuits, input/output subsystems, power supplies, and the like. Software routines 606, such as the methods for operating the gas distribution system 100 described herein, for example with respect to FIGS. 3, 4, and 5, may be stored in the memory 608 of the controller 600. The software routines 606, when executed by the CPU 602, transform the CPU 602 into a specific purpose computer (controller) 600. The software routines 606 may also be stored and/or executed by a second controller (not shown) that is located remotely from the controller 130.

Embodiments of the gas distribution system 100 were tested by the inventors over a range of desired flow ratios, several flow rates, and using multiple gases. The gas distribution system 100 met all accuracy requirements for etch processing at gas flows of 50 to 500 sccm. The repeatability of the gas distribution system 100 was found to be within 1 percent.

FIG. 3 depicts a flow diagram of a method 300 for dividing a gas in a desired flow ratio in accordance with some embodiments of the present invention. The method 300 generally begins at 302 where a desired flow ratio between a first gas delivery region 126 and a second gas delivery region 128 (and, optionally, additional gas delivery regions) may be selected. The desired flow ratio may generally be any flow ratio as designed into the gas distribution system 100, as discussed above. For example, depending upon the relationship between the sizes of the first and second orifices 110, 118, a number of flow ratios may be available for selection.

After the desired flow ratio is selected, at 304, a first selected set of a plurality of first orifices 110 selectively coupled to the first gas delivery region 126 is determined and a second selected set of a plurality of second orifices 118 selectively coupled to the second gas delivery region 128 that can provide the desired flow ratio is determined. Each of the first and second selected sets may include one or more orifices as required to provide the desired flow ratio.

In some embodiments, the first and second selected sets may be determined by choosing any one or more first orifices 110 and any one or more second orifices 118 that together provide the desired flow ratio. However, merely selecting any orifices may not provide a choked flow condition and/or may not provide a desired back pressure sufficient to prevent condensation of a low vapor pressure gas flowing through the gas distribution system 100. Accordingly, the inventors have further provided methods for selecting the set of first orifices 110 and the set of second orifices 118.

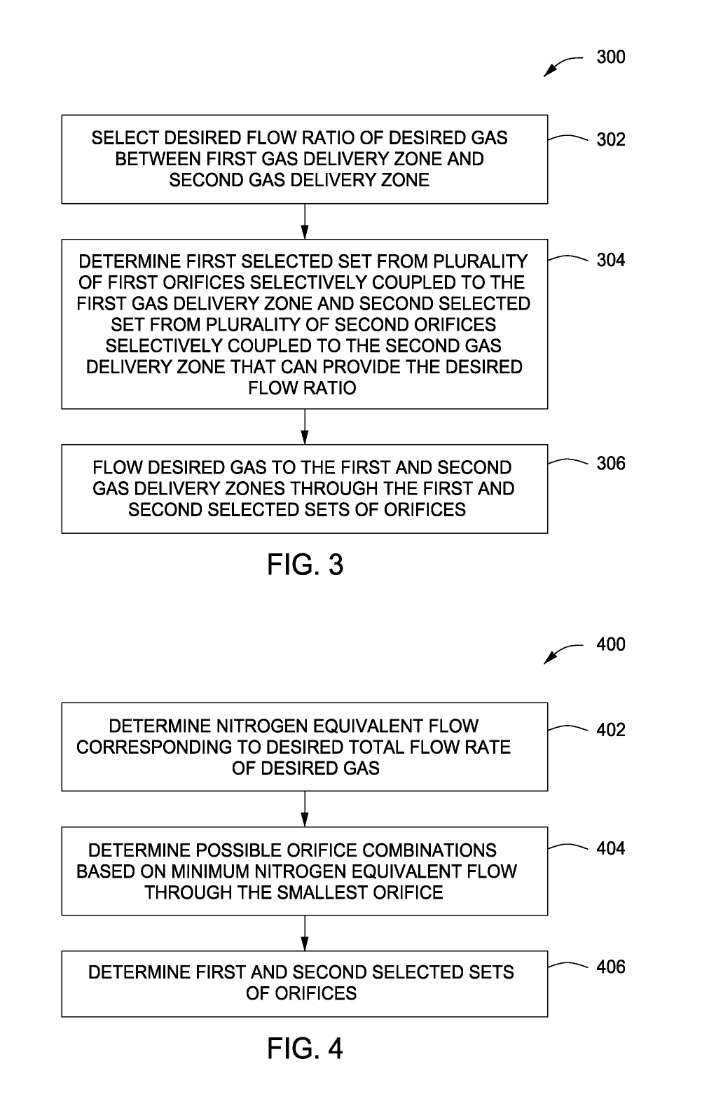

Determining the optimum set of orifices may include ensuring that the flows across the orifice stay in critical flow while minimizing the back pressure across the gas distribution system 100. The optimum set of orifices is a function of the composition of the gases flowing, the desired total flow rate, and the desired flow ratio. For example, FIG. 4 depicts a flow diagram of a method 400 for dividing a gas in a desired flow ratio in accordance with some embodiments of the present invention. The method 400 generally begins at 402 where a nitrogen equivalent flow corresponding to desired total flow rate of desired gas may be determined.

For example, in some embodiments, a nitrogen equivalent gas flow may be calculated using correction factors derived from thermodynamic equations. Specifically, the nitrogen equivalent gas flow can be determined by thermodynamic first principles if the heat capacity at constant pressure, the heat capacity at constant volume, and the molecular weight of each of the gases involved is known. All desired gas flows may be added together to determine the total flow for a given recipe step. Specifically, the total nitrogen equivalent gas flow may be calculated by the following formula (1):

Total Nitrogen Equivalent Flow=G₁*CF₁+G₂*CF₂+ . . . Gₙ*CFₙ (1)

In formula (1), Gₙ is the flow of a particular gas, and CFₙ is the conversion factor for that gas. The conversion factor for a particular gas may be derived from formulas (2) through (4):

CF=(Γₙₚ*√Mwₙ₂)/(Γₙ₂*√Mwₙₚ) (2)

Γ=SQRT(K*((2/(K+1))̂((K+1)/(K−1)))) (3)

K=Cp/Cv (4)

In formula (2), Γₙₚ and Γₙ₂ are respective constants for the gas of interest and nitrogen gas that may be determined by formulas 3 and 4. Mwₙₚ and Mwₙ₂ are the respective molecular weights of the gas of interest and nitrogen gas. In formula (3), K is a constant as defined by formula (4). In formula (4), Cp is the heat capacity at constant pressure and Cv is the heat capacity at constant volume for either the gas of interest (when calculating Γₙₚ) or for nitrogen gas (when calculating Γₙ₂).

Next, at 404, possible orifice combinations may be determined based on minimum nitrogen equivalent flow through the smallest orifice. For example, the nitrogen equivalent flow calculated above for the desired gas flow may be compared to a table of allowable minimum nitrogen equivalent flows to determine the smallest orifice that facilitates the desired gas flow.

Next at 406, once the smallest orifice size is determined, the first and second selected sets of orifices may be determined to provide the desired flow ratio. For example, in some embodiments, once the smallest orifice is known, a single larger orifice may be selected to provide the desired flow ratio (i.e., the first set contains one orifice and the second set contains one orifice). In some embodiments, more than one larger orifice may be provided in either or both of the first and second sets in order to provide the desired flow ratio. For example, two or more larger orifices may be combined to provide a first gas flow through one of the flow control manifolds and the smallest orifice (or the smallest orifice plus one or more larger orifices) may be used to provide a second gas flow through the other of the flow control manifolds. The first and second gas flows combined provide the total gas flow and are provided in the desired flow ratio in a choked flow condition.

Alternatively, at 404, possible orifice combinations may be determined based on minimum nitrogen equivalent flow through the smallest large orifice, then at 406, the first and second selected sets of orifices may be determined to provide the desired flow ratio based upon the large orifice size determined at 404. For example, once the large orifice size is known, a single small orifice may be selected to provide the desired flow ratio (e.g., the first set contains one orifice and the second set contains one orifice), or a plurality of small orifices may be provided in either or both of the first and second sets in order to provide the desired flow ratio.

In some embodiments, the combinations of orifices available to provide the desired flow ratios may be provided in a table that may be referenced, for example, by the controller in order to automatically determine the first and second sets based upon a desired gas flow and flow ratio that is entered manually or as part of a process recipe. In some embodiments, the table may indicate which combinations of orifices may be selected in order to maintain a choked flow condition and/or to maintain a desired minimum upstream pressure, as discussed above.

Further, the method 400 (as well as a method 500 discussed below) need not be limited to determining the nitrogen equivalent flow corresponding to a desired flow rate of a desired gas. For example, one or more of argon equivalent flow, pressure equivalent flow, modeled fluid dynamics, or the like may be utilized to determine selection criteria for sets of orifices.

Returning to FIG. 3, next, at 306, a gas flow to the first and second gas delivery regions 126, 128 may be provided through the first and second selected sets of orifices, thereby providing the gas flow in the desired flow ratio, as discussed above.

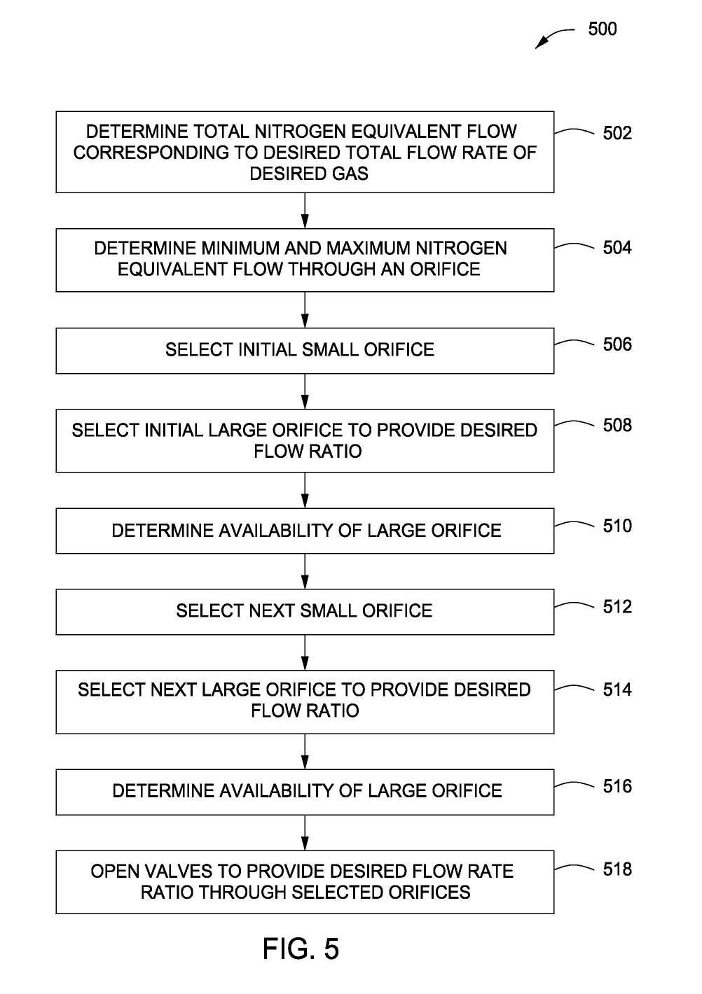

In some embodiments, an inventive method of determining a desired set of orifices is provided based upon ensuring that the gas flows across each orifice stays in critical flow while minimizing the back pressure across the gas distribution system 100. The desired set of orifices may be a function of the desired gases, the flow rates, and the desired ratio. For example, FIG. 5 depicts a flow diagram for dividing a gas in a desired flow ratio in accordance with some embodiments of the present invention that may advantageously facilitate selection of the orifices in a manner that provides the above benefits. The method 500 of FIG. 5 is used to select two single orifices (e.g., one first orifice 110 and one second orifice 118) that provide the desired flow ratio with respect to each other.

The method 500 generally begins at 502 where a total nitrogen equivalent flow corresponding to a desired total flow rate of a desired gas may be determined. The total nitrogen equivalent flow (TNEF) may be determined as discussed above with respect to FIG. 4. In some embodiments, a table may be determined to provide a conversion factor for one or more gases of interest. For example, the table may include conversion factors for gases typically used in a particular process chamber, plurality of process chambers, within a fabrication facility, or any desired set of gases. In some embodiments, the table may be stored electronically, for example in a memory (e.g., 608) of the controller (e.g., 600) or a memory that is accessible by the controller, such that the controller may access the table when needed, such as when the controller is performing all or a subset of the method 500.

Next, at 504, the minimum and maximum nitrogen equivalent flow through an orifice may be determined. The minimum and maximum nitrogen equivalent flow corresponds to the total flow rate of the gas or gases being provided and the desired flow ratio. The minimum and maximum nitrogen equivalent flows through an orifice may be respectively determined by formulas (5) and (6):

Mmin=TNEF/(R+1) (5)

Mmax=TNEF*R/(R+1) (6)

In formulas (4) and (5), Mmin is the minimum nitrogen equivalent flow and Mmax is the maximum nitrogen equivalent flow through an orifice, TNEF is the total nitrogen equivalent flow as calculated at 502 above, and R is the desired flow ratio expressed decimally (e.g., 1:1=1, 2:1=2, etc.).

Next, at 506, an initial small orifice may be selected. The small orifice may be a first orifice 110 or a second orifice 118 (with reference to FIG. 1) depending upon which gas delivery zone (126, 128) is to receive the lesser gas flow. In some embodiments, the selected small orifice may be the largest sized orifice that will still provide choked flow. This may be determined for example, by using the modeling software discussed above. In some embodiments, a table of predetermined minimum and maximum flows for each orifice may be provided. The table may be stored in a memory (e.g., 608) that is accessible by the controller (e.g., 600) such that software instructions causing the controller to perform the method 500 may look at the table and determine the largest orifice where the minimum nitrogen equivalent flow (Mmin) is greater than or equal to the minimum flow for that particular orifice. If the minimum nitrogen equivalent flow is less than the smallest minimum flow supported (i.e., the minimum flow required by the smallest orifice), the software may provide an alarm to tell the user that the requested flow and ratio is outside of the operating range of the gas distribution system 100.

Next, at 508, an initial large orifice required to provide the desired flow ratio may be selected. The large orifice may be a first orifice 110 or a second orifice 118 (with reference to FIG. 1) depending upon which gas delivery zone (126, 128) is to receive the greater gas flow. The large orifice may be selected by multiplying the selected small orifice by the desired flow ratio.

Next, at 510, the availability of the selected large orifice must be determined. The availability of the selected large orifice may be determined by comparing the calculated maximum nitrogen equivalent flow (Mmax) to ensure that it falls within the range of available flows supported by the selected orifice (i.e., Mmax must be equal to or greater than the minimum flow required through the orifice and equal to or less than the maximum flow required through the orifice). In some embodiments, the minimum and maximum flows through each of the orifices may be provided in a table and may be accessible by the controller in order to allow the controller to determine whether the selected large orifice is available.

If, at 510, the selected large orifice is available, the method 500 proceeds to 518, as discussed below. If, however, the selected large orifice is unavailable, the method 500 proceeds to 512, where the next smaller small orifice is selected and verified as discussed above at 506. At 514, the next large orifice to provide the desired flow ratio is determined as discussed above at 508. At 516 the availability of the large orifice is again determined, as discussed above at 510. If, at 516, the selected large orifice is available, the method 500 proceeds to 518, as discussed below. If, however, the selected large orifice is unavailable, the method 500 repeats 512 through 516, selecting incrementally smaller small orifices, determining the corresponding large orifice required to provide the desired flow rate, and verifying the availability of the large orifice. If at any time the routine runs out of orifices to select, then the method ends and the gas distribution system 100 cannot provide the desired gas flow and flow ratio while maintaining the desired choked flow an minimal back pressure.

Once the large orifice has been determined, at 518, corresponding control valves may be opened to provide the desired flow rate ratio through the selected orifices. In some embodiments, a table may be provided indexing respective control valves and corresponding orifices. As such, by reference to the table, an operator or controller may open the control valves (112, 120) corresponding to the selected orifices. Upon determining the selected sets of orifices and opening the corresponding valves, the method 500 generally ends.

The method 500 may also be modified to select a plurality of orifices within each set of selected orifices. For example, the smallest and largest nitrogen equivalent flows through each orifice may be calculated based upon further splitting the flow through a plurality of orifices, rather than through a single orifice. Upon determining the selected sets of first orifices 110 and second orifices 118 required to provide the desired flow ratio at the desired total flow rate, the corresponding control valves 112, 120 may be opened to provide the gas flow to the gas delivery zones 126, 128.

The above methods may be similarly utilized to provide gas to a third or more additional gas delivery zones using the same techniques as discussed above. The third (or more) gas delivery zones may correspond to additional zones in a given process chamber, additional different process chambers, or combinations thereof. For example, similar to the methods discussed above, a desired flow ratio of the desired gas between a third gas delivery zone and either or both of the first gas delivery zone and the second gas delivery zone may be selected. Then, a third selected set from a plurality of third orifices selectively coupled to the third gas delivery zone that can provide the desired flow ratio may be selected. The desired gas may then be flowed to the third delivery zone in the desired flow ratio through the third selected set of orifices.

Thus, embodiments of the present invention provide methods and apparatus for distributing a desired gas flow to two or more desired gas delivery zones over a range of desired flow ratios. The inventive methods and apparatus may advantageously provide a range of desired flow ratios, while providing choked flow for a specific combination of gas flow and prevention of phase change of low vapor pressure gases. The inventive methods and apparatus further provide an indication when a specific ratio cannot be achieved by either due to inability to maintain choked flow or by exceeding the upstream pressure required to prevent phase change of the process gases flowing through the gas distribution system.

The inventive gas distribution system does not use sensors and thus advantageously does not drift over time. As such, the inventive gas distribution system does not require periodic zero offset and span checks. In addition, the inventive gas distribution system has a mean time to replace (MTTR) that is expected to be improved over sensor-based flow controller due to the high reliability of the control valves and by not utilizing active electronics or sensors. Moreover, the inventive gas distribution system does not have a heated sensor so the mixed gases are not exposed to elevated temperatures where undesirable reactions can take place. The inventive gas distribution system further possesses a wider operating range than conventional sensor-based flow ratio controllers since it is not limited by the scale of the flow sensor. Also, the response time is advantageously lessened for the inventive gas distribution system because no closed loop control is required for operation.

While the foregoing is directed to embodiments of the present invention, other and further embodiments of the invention may be devised without departing from the basic scope thereof.

1. Apparatus for controlling gas distribution to multiple gas delivery zones, comprising:
a mass flow controller to provide a desired total gas flow;
a first flow control manifold comprising a first inlet, a first outlet, and a plurality of first orifices selectably coupled therebetween, wherein the first inlet is coupled to the mass flow controller; and
a second flow control manifold comprising a second inlet, a second outlet, and a plurality of second orifices selectably coupled therebetween, wherein the second inlet is coupled to the mass flow controller;
wherein the plurality of first orifices and the plurality of second orifices provide a desired flow ratio between the first outlet and the second outlet by selectably causing the fluid to flow through one or more of the plurality of first orifices and one or more of the plurality of second orifices and wherein the conductance of a conduit provided between the mass flow controller and the respective inlets of the first and second flow control manifolds is sufficient to provide a choked flow condition when flowing a gas through the apparatus.

2. The apparatus of claim 1, wherein the first outlet is coupled to a first gas delivery zone of a first process chamber and the second outlet is coupled to a second gas delivery zone of the first process chamber.

3. The apparatus of claim 2, wherein the first outlet is further coupled to a first gas delivery zone of a second process chamber and the second outlet is further coupled to a second gas delivery zone of the second process chamber.

4. The apparatus of claim 1, wherein the first outlet is coupled to a gas delivery zone of a first process chamber and the second outlet is coupled to a gas delivery zone of a second process chamber.

5. The apparatus of claim 1, wherein the first and second flow control manifolds provide a pressure drop sufficient to maintain a restricted pressure upstream of the first and second flow control manifolds

6. The apparatus of claim 5, wherein the restricted upstream pressure is at least one of:
less than about 155 Torr;
low enough to prevent condensation of low vapor pressure gases; or
controlled to optimize the response time of the system.

7. A method for controlling gas distribution to multiple gas delivery zones, comprising:
selecting a desired flow ratio of a desired gas between a first gas delivery zone and a second gas delivery zone;
determining a first selected set from a plurality of first orifices selectively coupled to the first gas delivery zone and a second selected set from a plurality of second orifices selectively coupled to the second gas delivery zone that can provide the desired flow ratio; and
flowing the desired gas to the first and second gas delivery zones through the first and second selected sets of orifices.

8. The method of claim 7, wherein determining the first selected set and the second selected set further comprises:
determining a total nitrogen equivalent flow corresponding to a desired total flow rate of the desired gas; and
determining possible orifice combinations based on minimum nitrogen equivalent flow through the smallest selected orifice.

9. The method of claim 7, wherein determining the first selected set and the second selected set further comprises either:
determining a first small orifice out of the plurality of first orifices, selecting a corresponding first large orifice out of the plurality of second orifices, and determining an availability of the first large orifice; or
determining a first large orifice out of the plurality of first orifices, selecting a corresponding first small orifice out of the plurality of second orifices, and determining an availability of the first small orifice.

10. The method of claim 9:
wherein determining the first small orifice out of the plurality of first orifices is based upon predetermined allowable maximum and minimum nitrogen equivalent gas flows through an orifice having the same size as the first small orifice, and wherein determining the availability of the first large orifice is based upon predetermined allowable maximum and minimum nitrogen equivalent gas flows through an orifice having the same size as the first large orifice; or
wherein determining the first large orifice out of the plurality of first orifices is based upon predetermined allowable maximum and minimum nitrogen equivalent gas flows through an orifice having the same size as the first large orifice, and wherein determining the availability of the first small orifice is based upon predetermined allowable maximum and minimum nitrogen equivalent gas flows through an orifice having the same size as the first small orifice.

11. The method of claim 10, wherein the allowable maximum and minimum nitrogen equivalent gas flows through each orifice is predetermined to provide an upstream pressure that is greater than or equal to two times a downstream pressure, wherein the upstream pressure is measured between a mass flow controller that provides the desired gas and the first and second orifices, and wherein the downstream pressure is measured between the first and second orifices and the first and second gas delivery zones.

12. The method of claim 9, wherein upon determining an unavailability of the first large orifice, further comprising:
selecting a second small orifice, wherein the second small orifice is smaller than the first small orifice;
selecting a corresponding second large orifice to provide the desired flow ratio; and
determining an availability of the second large orifice.

13. The method of claim 12, wherein upon determining an unavailability of the second large orifice, further comprising:
repeating the limitations of claim 12 as applied to sequential small orifices and corresponding large orifices until either both the small orifice and the large orifice are available or no small orifice and corresponding large orifice have been determined to be available; and
optionally, upon determining that no small orifice and corresponding large orifice are available, indicating that the desired total flow rate and the desired flow ratio are not able to be provided.

14. The method of claim 7, further comprising:
opening control valves corresponding to the first and second selected sets of orifices to provide desired flow rate ratio through the selected orifices.

15. The method of claim 7, wherein the first gas delivery zone is a first zone within a first process chamber and wherein the second gas delivery zone is a second zone within the first process chamber.

16. The method of claim 15, further comprising:
selecting a desired flow ratio of the desired gas between a third gas delivery zone corresponding to a third zone in the first process chamber and either or both of the first gas delivery zone and the second gas delivery zone;
determining a third selected set from a plurality of third orifices selectively coupled to the third gas delivery zone that can provide the desired flow ratio; and
flowing the desired gas to the third delivery zone in the desired flow ratio through the third selected set of orifices.

17. The method of claim 15, wherein the first and second zones correspond to an inner zone and an outer zone of a showerhead disposed within the first process chamber.

18. The method of claim 7, wherein the first gas delivery zone is a first zone within a first process chamber and wherein the second gas delivery zone is a first zone within a second process chamber.

19. The method of claim 18, wherein the first gas delivery zone further includes a second zone in the second process chamber and wherein the second gas delivery zone further includes a second zone in the first process chamber.

20. The method of claim 18, further comprising:
selecting a desired flow ratio of the desired gas between a third gas delivery zone corresponding to a first zone in a third process chamber and either or both of the first gas delivery zone and the second gas delivery zone;
determining a third selected set from a plurality of third orifices selectively coupled to the third gas delivery zone that can provide the desired flow ratio; and
flowing the desired gas to the third delivery zone in the desired flow ratio through the third selected set of orifices.
